(19) United States
(12) Patent Application Publication
(10) Pub. No.: US 2016/0034604 A1
(43) Pub. Date: Feb. 4, 2016

(54) Casting Design Advisor Toolkit

(71) Applicant: Caterpillar Inc., Peoria, IL (US)

(72) Inventors: Zhiping Lin, Dunlap, IL (US); Li Zhang, Dunlap, IL (US); Adrian V. Catalina, Germantown Hills, IL (US); Zhiyong Hu, Chicago, IL (US); Chunsheng Li, Fishers, IN (US); Daniel A. Gorsky, Dunlap, IL (US); Krishna K anth Konjeti, Dunlap, IL (US); Weizhou Li, Peoria, IL (US)

(73) Assignee: Caterpillar Inc., Peoria, IL (US)

(21) Appl. No.: 14/451,402

(22) Filed: Aug. 4, 2014

(51) Int. Cl. G06F 17/50

(52) U.S. Cl. CPC G06F 17/50

(57) ABSTRACT

A system for providing casting design advisement for designing a cast component is provided. The system includes an integrated design environment, the integrated design environment receiving a concept design for the cast component, the concept design being user-modifiable. The system also includes a plurality of design advisory modules, the plurality of design advisory modules determining physics models associated with the concept design for the cast component and providing advisement analysis for the concept design based on the physics models. The system includes a design rule logic solver for receiving concept design features associated with the concept design and comparing the concept design features with stored casting design rules to determine a geometry modification guide.

### TECHNICAL FIELD OF THE DISCLOSURE

The present disclosure generally relates to casting analysis tools and, more particularly, relates to systems and methods for providing casting design advisement for designing a cast component.

### BACKGROUND OF THE DISCLOSURE

When designing cast components for machines, designers and engineers may use a variety of systems and methods to optimize the design of the cast component prior to manufacture. In such machines, casting provides a more affordable way to produce individual components because casting methods can produce geometrically complex components in mass quantity. Casting is especially beneficial in producing components having light weight structural materials.

Modern casting design processes often include the aid of computers during design because the computer, and associated software, provides automated design environments. Designers may use a variety of computer software during the design process, such as computer aided manufacturing (CAM) software, computer aided drafting (CAD) software, computer aided engineering (CAE) software, and the like. Such automated design software can lead to more efficient casting design and production.

Because the design process often involves analysis and optimization based on geometric specifications of a cast component, associated modelling software is useful in determining various advantages and disadvantages of cast component designs based on component geometry. For example, component geometry may affect material performance under casting manufacturing conditions. Therefore, software modelling may be useful in simulating effects on geometry during casting manufacturing conditions.

Cast component designers may use a variety of commercial software products to simulate physics states based on the geometry of the cast component and effects of casting manufacturing conditions on the geometry. Often, said commercial software is expensive and very complex. The software may be so complex that it can only be used by a user who has been well trained and has expert knowledge of the software. Further, such software is not integrated into the design environment (e.g., engineering design software such as a Pro/Engineering environment) and may take a prohibitively long time to execute. Therefore, a need exists for a design tool which provides affordable, efficient, and integrated geometry analysis for a cast component design.

### SUMMARY OF THE DISCLOSURE

In accordance with one aspect of the present disclosure, a system is provided for providing casting design advisement for designing a cast component. The system may include an integrated design environment, the integrated design environment receiving a concept design for the cast component, the concept design being user-modifiable. The system may also include a plurality of design advisory modules associated with the integrated design environment, the plurality of design advisory modules determining physics models associated with the concept design for the cast component and providing advisement analysis for the concept design based on the physics models. In some examples, the plurality of design advisory modules may include one or more of a material performance module, a solidification module, a heat treatment module, a hot tear analysis module, and a machining analysis module. Further, the system may include a design rule logic solver for receiving concept design features associated with the concept design and comparing the concept design features with stored casting design rules to determine a geometry modification guide.

In accordance with another aspect of the present disclosure, a method is provided for providing advisement for designing a casting component. The method may include receiving a concept design for the cast component at an integrated design environment, the concept design being user-modifiable. The method may include determining physics models associated with the concept design for the casting component using a plurality of design advisory modules and providing advisement analysis for the concept design based on the physics models. In some examples, the plurality of design advisory modules may include one or more of a material performance module, a solidification module, a heat treatment module, a hot tear analysis module, and a machining analysis module. The method may include receiving, by a design rules logic solver, concept design features associated with the concept design and determining, using the design rule logic solver, a geometry modification guide by comparing the casting design features with stored casting design rules.

In accordance with yet another aspect of the present disclosure, a non-transitory, computer readable medium having thereon computer-executable instructions for providing advisement for designing a cast component is disclosed. The instructions may include instructions for receiving a concept design for the cast component at an integrated design environment, the concept design being user-modifiable. The instructions may include instructions for determining physics models associated with the concept design for the cast component using a plurality of design advisory modules and instructions for providing advisement analysis for the concept design based on the physics models. In some examples, the plurality of design advisory modules may include one or more of a material performance module, a solidification module, a heat treatment module, a hot tear analysis module, and a machining analysis module. The instructions may include instructions for receiving concept design features associated with the concept design by a design rule logic solver and instructions for determining a geometry modification guide by comparing the casting design features with stored casting design rules.

Other features and advantages of the disclosed systems and principles will become apparent from reading the following detailed disclosure in conjunction with the included drawing figures.

### BRIEF DESCRIPTION OF THE DRAWINGS

FIG. 1 is a schematic diagram for an exemplary system for providing casting design advisement in accordance with the present disclosure.

FIG. 2 is a flowchart for an exemplary method for providing casting design advisement in accordance with the present disclosure.

FIG. 3 is a flowchart further detailing the exemplary step of determining physics models of FIG. 2, in accordance with the present disclosure.

FIG. 4 is a schematic diagram for an example computer that may execute instructions for providing the example systems and methods of the present disclosure.

FIG. 5 is an example output of a computer providing a design environment associated with the systems and methods of the present disclosure.

FIG. 6 is an example output of a computer providing an example physics state analysis associated with the systems and methods of the present disclosure.

FIG. 7 is an example output of a computer providing example geometry features analysis associated with the systems and methods of the present disclosure.

While the following detailed description will be given with respect to certain illustrative embodiments, it should be understood that the drawings are not necessarily to scale and the disclosed embodiments are sometimes illustrated diagrammatically and in partial views. In addition, in certain instances, details which are not necessary for an understanding of the disclosed subject matter or which render other details too difficult to perceive may have been omitted. It should therefore be understood that this disclosure is not limited to the particular embodiments disclosed and illustrated herein, but rather to a fair reading of the entire disclosure and claims, as well as any equivalents thereto.

### DETAILED DESCRIPTION OF THE DISCLOSURE

The present disclosure provides systems and methods for providing casting design advisement for designing a cast component. Such systems and methods may be integrated as a casting design advisor toolkit (CDAT) for quickly and easily exploring the casting geometry design as it relates to manufacturability. The following disclosure provides CDATs for providing designers and engineers with integrated, interactive design analysis based on cast component geometry.

Such systems and methods for providing a CDAT may be integrated within engineering software used in cast component design, such as, for example, computer aided design (CAD) software, computer aided engineering (CAE) software, Pro/Engineering software, and the like. The CDAT may provide analysis based on geometric features of concept designs for cast components which are input to the engineering software.

Example CDATs provided may develop accurate physics models for a variety of physics based models associated with the geometric features of a concept design for a cast component. The physics models may be used for design advisement by analyzing conditions associated with the input casting component design, such as casting solidification, material performance, heat treatment, machining, and manufacturing cost. Output of design advisory processes may be shown in the interactive design environment by mapping potential defects and/or design issues on an input cast design. Based on the output provided by the CDAT in the interactive design environment, a user may modify the concept design based on the results.

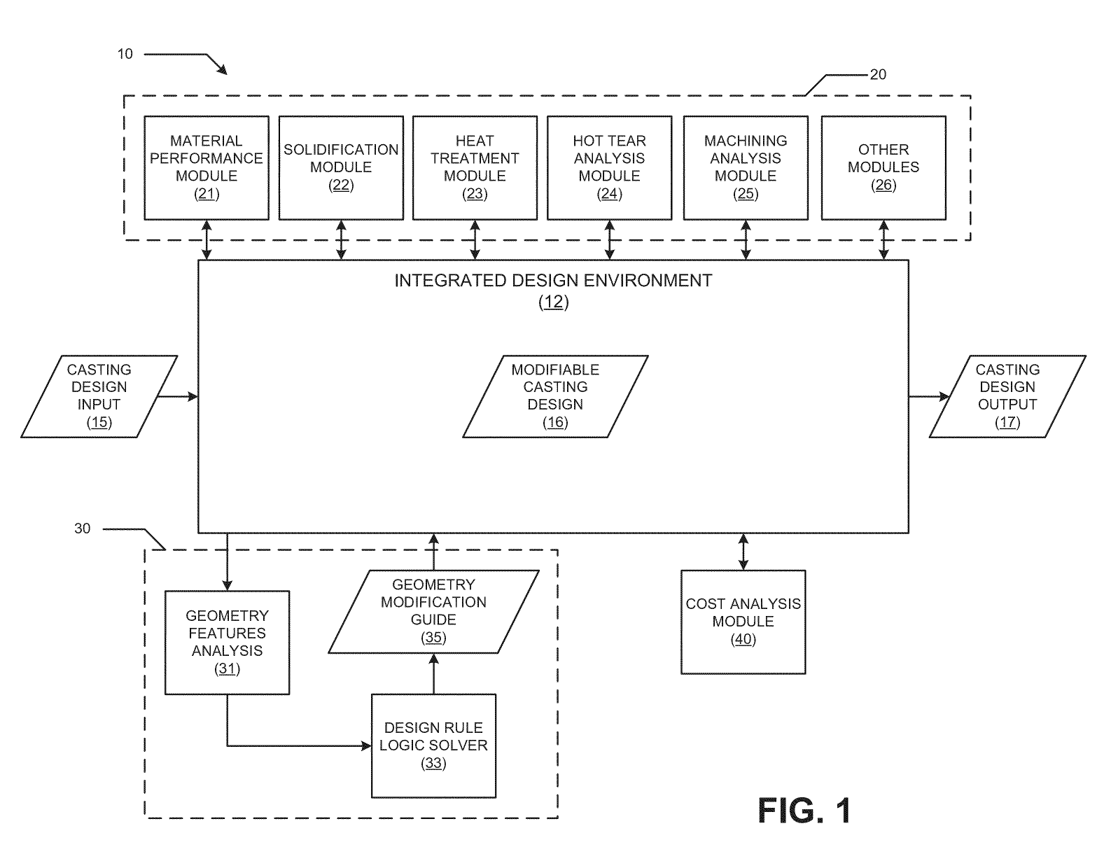

Turning now to the drawings, and with specific reference to FIG. 1, an example schematic diagram is shown for a CDAT system 10 for providing casting design advisement. The CDAT system 10 receives casting design input 15 to provide a concept design for a cast component as a modifiable casting design 16 in an integrated design environment 12. The integrated design environment 12 is a design environment integrated into and/or embedded into a computer-aided design environment. The integrated design environment 12 may collect, provide, and/or update geometry information associated with the modifiable casting design 16 to continually update features of the modifiable casting design 16. Through the integrated design environment 12, a user may interact with modules that conduct physics based analysis, identify manufacturing issues, provide the visualized results, and provide casting design guides for manufacturability. Potential issues and design guides from modules may be displayed in the integrated design environment 12 and designers may modify the geometry of the modifiable casting design 16 based on said design guides.

As mentioned above, the integrated design environment 12 may be associated with a variety of modules of the CDAT. Such modules may include, but are not limited to including, a plurality of design advisory modules 20, a geometry analysis module 30, and a cost analysis module 40.

The plurality of design advisory modules 20 determine physics models associated with the modifiable casting design 16 and provide advisement analysis for the modifiable casting design 16 based on the physics models. Example design advisor models 20 may include, but are not limited to including a material performance module 21, a solidification module 22, a heat treatment module 23, a hot tear analysis module 24, and a machining analysis module 25. Any other modules 26 for design advisement may be included as well. All design advisory modules 20 operate in parallel when determining advisement analysis to a user of the CDAT system 10.

The material performance module 21 may conduct material performance analysis on the modifiable casting design 16. Such analysis may predict possible microstructure and mechanical properties for the design. Further, the material performance module 21 provides physics models for analyzing if the casting component can meet performance requirements based on characteristics of the modifiable casting design 16, the characteristics including, but not limited to, geometry design, material selections, and manufacturing processes. Analysis of the physics models determined by the material performance module may suggest, to the user, geometry modifications, material improvements, and/or optimal manufacturing processes for the modifiable casting design 16.

The solidification module 22 provides physics analysis for performing solidification analysis on the casting component design. Solidification analysis provides a simulation for when a material for a cast component is distributed into a cast mold as a liquid and subsequently solidifies. Because the solidification process may affect the final cast component product, a user may want to analyze and potentially modify the modifiable casting design 16 based on solidification effects. The solidification module 22 performs such analysis to identify potential shrinkage issues. Based on the solidification analysis results, a user may receive feedback from the solidification module 22, suggesting to modify the casting geometry to reduce and/or eliminate potential shrinkage when the part is cast in a foundry.

Various heat-related conditions may affect the design of the modifiable casting design 16. The heat treatment module 23 is provided to provide physics models and analysis based on potential heat treatment processes for a casting component. Such analysis provides designers with feedback on properties of the cast component which may be affected during heat treatment processes, such as hardness, microstructure, residual stress, distortion, and potential cracks.

Further, the hot tear analysis module 24 may be provided to perform thermal stress analysis on the modifiable casting design 16, checking for potential hot tear problems. Hot tears are failures in the casting that occur as the casting cools in the mold because the metal is weak when hot and the residual stresses in the material can cause the casting to fail as it cools. The hot tear analysis module 24 provides advisement to a user to modify the geometry of the modifiable casting design 16 to reduce the thermal stress and potential hot tears caused by the geometric design.

The machining analysis module 25 may be provided to provide physics models for checking fixture information of the modifiable casting design 16 to aid designers in choosing the correct fixture location. Using the analysis provided by the machining analysis module 25, the designers may learn of design issues of the geometry features that may influence a casting machining process.

Returning now to the geometry analysis module 30 of FIG. 1, casting design features are extracted from the modifiable casting design 16 by a geometry features analysis 31. The extracted casting design features are received by a design logic solver 33. The design logic solver may analyze the extracted casting design features. Such analysis may include comparing the extracted casting design features with prior known geometry features based on casting design rules. The known geometry features may be stored in a design database associated with the solver. The results of analysis by the design logic solver 33 are provided to the integrated design environment 12 as a geometry modification guide 35. The geometry modification guide 35 may be used by a user to modify the modifiable casting design 16.

The cost analysis module 40 may be provided to perform a cost analysis for production of the cast component simulated by the modifiable casting design 16. Based on the analysis provided by the cost analysis module 40, a designer may modify the modifiable casting design 16 for cost efficiency based on casting geometry, materials, and/or manufacturing processes.

The provided modules of CDAT 10 may all analyze features of the modifiable casting design 16 in parallel (e.g., by using parallelized solvers) to provide casting advisement to the user. Once the user has performed any desired modifications, the CDAT 10 may output casting design output 17. The casting design output 17 may be used to produce a mold, which may be used by a foundry to produce a cast component.

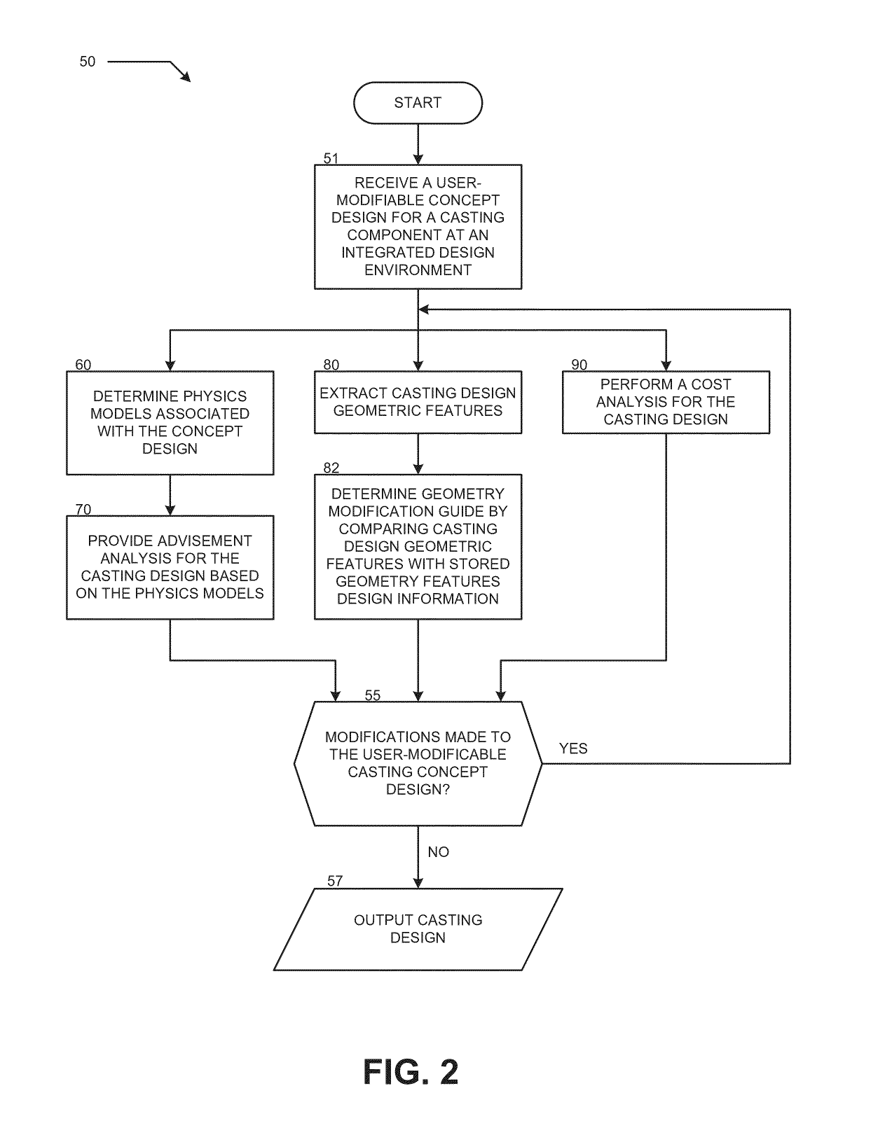

A flowchart representative of an example method 50 for providing advisement for designing a casting component is shown in FIG. 2. The method 50 may be performed using the CDAT system 10 of FIG. 1. As such, like reference numerals are used when describing elements of the CDAT system 10 as they relate to the method 50.

Starting at block 51, a user-modifiable concept design for a casting component (e.g., the modifiable casting design 16) is received at the integrated design environment 12. Once received, the concept design may analyzed, as detailed below with reference to blocks 60, 70, 80, 82, and 90.

At block 60, the CDAT 10 may determine physics models associated with the concept design. Such physics models may be determined by the plurality of design advisement modules 20. Once the physics models are determined, the CDAT 10 may provide advisement analysis for the casting design based on the physics models (block 70).

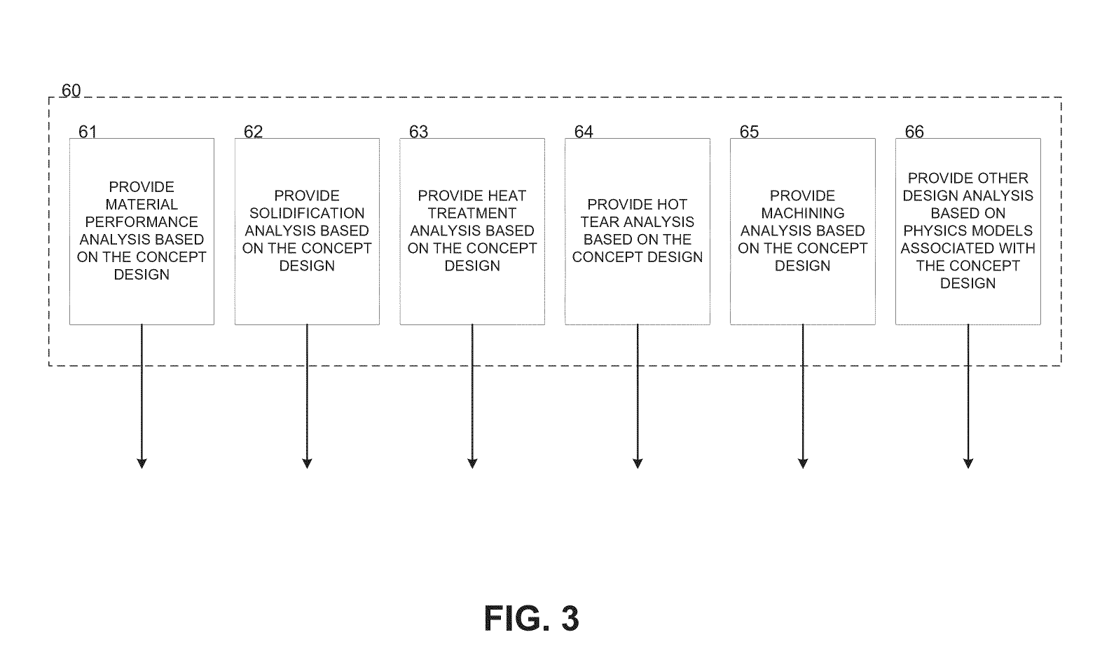

FIG. 3 shows detailed processes which may be performed as part of block 60, using the plurality of design advisement modules 20. At block 61, the material performance module may provide material performance analysis on the modifiable casting design 16. The CDAT 10 may provide solidification analysis on the modifiable casting design 16 (block 62), the results of which may be used to advise the user regarding solidification issues. Further, heat treatment analysis may be performed to detect and analyze casting issues associated with heat treatment (block 63). At block 64, a hot tear analysis may be performed, determining if any unwanted hot tear effects may be present upon casting; such analysis is used in preventing hot tear from occurring during casting. Additionally, a machining analysis may be performed to determine proper fixture location and determine design issues which may influence the casting machining process (block 65). Any other physics based casting design advisement may be performed as well (block 66).

Returning now to FIG. 2, the method 50 may include extracting geometric features associated with the modifiable casting design 16 (block 80). Using the extracted geometric features, the CDAT 10 may determine a geometry modification guide by comparing the geometric features with stored casting design rules or guidelines (block 82).

At block 90, the CDAT 10 may perform a cost analysis for the casting design. The CDAT 10 may provide cost analysis for production of the cast component represented by the modifiable casting design 16. Based on the analysis provided, a designer may modify the modifiable casting design 16 for cost based on casting geometry, materials, and/or manufacturing processes.

After the user has analyzed the modifiable casting design 16 using one or more of steps 60, 70, 80, 82, and 90, the user may modify the modifiable casting design 16 based on the obtained analysis (block 55). If the user is not satisfied with the design, he/she may modify the user modifiable casting design 16 and decide to analyze the newly modified casting design 16 using the steps of the method 50. If the user is satisfied with the design, it may be output as an output casting design (block 57).

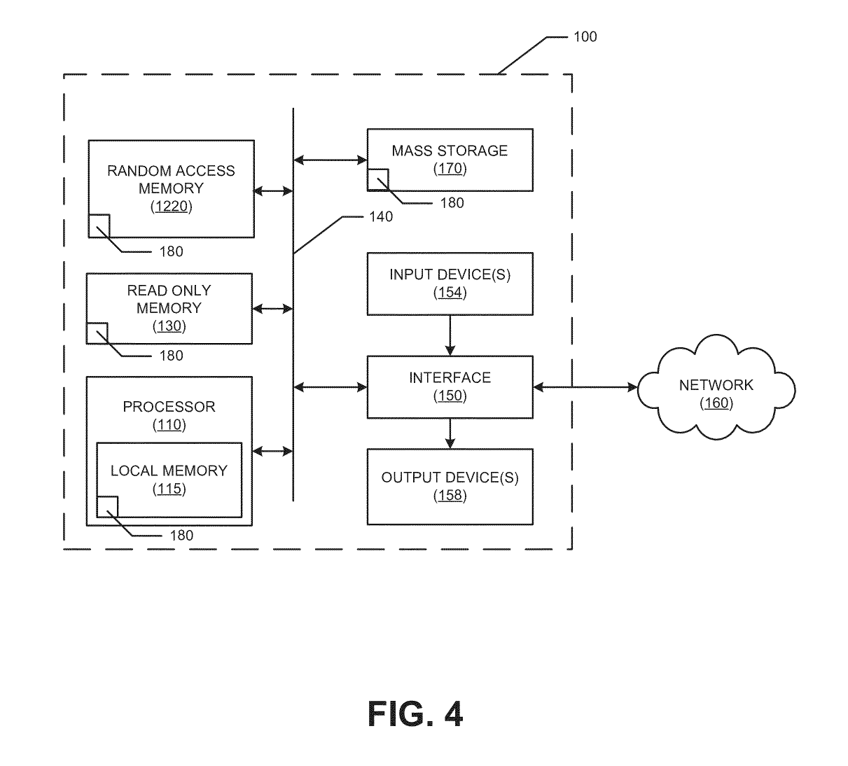

FIG. 4 is a block diagram of an example computer 100 capable of executing the systems and methods of the present disclosure. The computer 100 can be, for example, a server, a personal computer, or any other type of computing device.

The computer 100 of the instant example includes a processor 110. For example, the processor 110 can be implemented by one or more microprocessors or controllers from any desired family or manufacturer.

The processor 110 includes a local memory 115 and is in communication with a main memory including a read only memory 130 and a random access memory 120 via a bus 140. The random access memory 120 may be implemented by Synchronous Dynamic Random Access Memory (SDRAM), Dynamic Random Access Memory (DRAM), RAMBUS Dynamic Random Access Memory (RDRM) and/or any other type of random access memory device. The read only memory 130 may be implemented by a hard drive, flash memory and/or any other desired type of memory device.

The computer 100 also includes an interface circuit 150. The interface circuit 130 may be implemented by any type of interface standard, such as, for example, an Ethernet interface, a universal serial bus (USB), and/or a PCI express interface. One or more input devices 154 are connected to the interface circuit 150. The input device(s) 154 permit a user to enter data and commands into the processor 110. The input device(s) can be implemented by, for example, a keyboard, a mouse, a touchscreen, a track-pad, a trackball, isopoint and/or a voice recognition system.

One or more output devices 158 are also connected to the interface circuit 150. The output devices 158 can be implemented by, for example, display devices for associated data (e.g., a liquid crystal display, a cathode ray tube display (CRT), etc.).

The computer 100 may be used to execute machine readable instructions. For example, the computer 100 may execute machine readable instructions to perform the method 50 shown in the block diagrams of FIGS. 2 and 3. In such examples, the machine readable instructions comprise a program for execution by a processor such as the processor 110 shown in the example computer 100. The program may be embodied in software stored on a tangible computer readable medium such as a CD-ROM, a floppy disk, a hard drive, a digital versatile disk (DVD), a Blu-ray disk, or a memory associated with the processor 110, but the entire program and/or parts thereof could alternatively be executed by a device other than the processor 110 and/or embodied in firmware or dedicated hardware. Further, although the example programs are described with reference to the flowcharts illustrated in FIGS. 2 and 3, many other methods of implementing embodiments of the present disclosure may alternatively be used. For example, the order of execution of the blocks may be changed, and/or some of the blocks described may be changed, eliminated, or combined.

### INDUSTRIAL APPLICABILITY

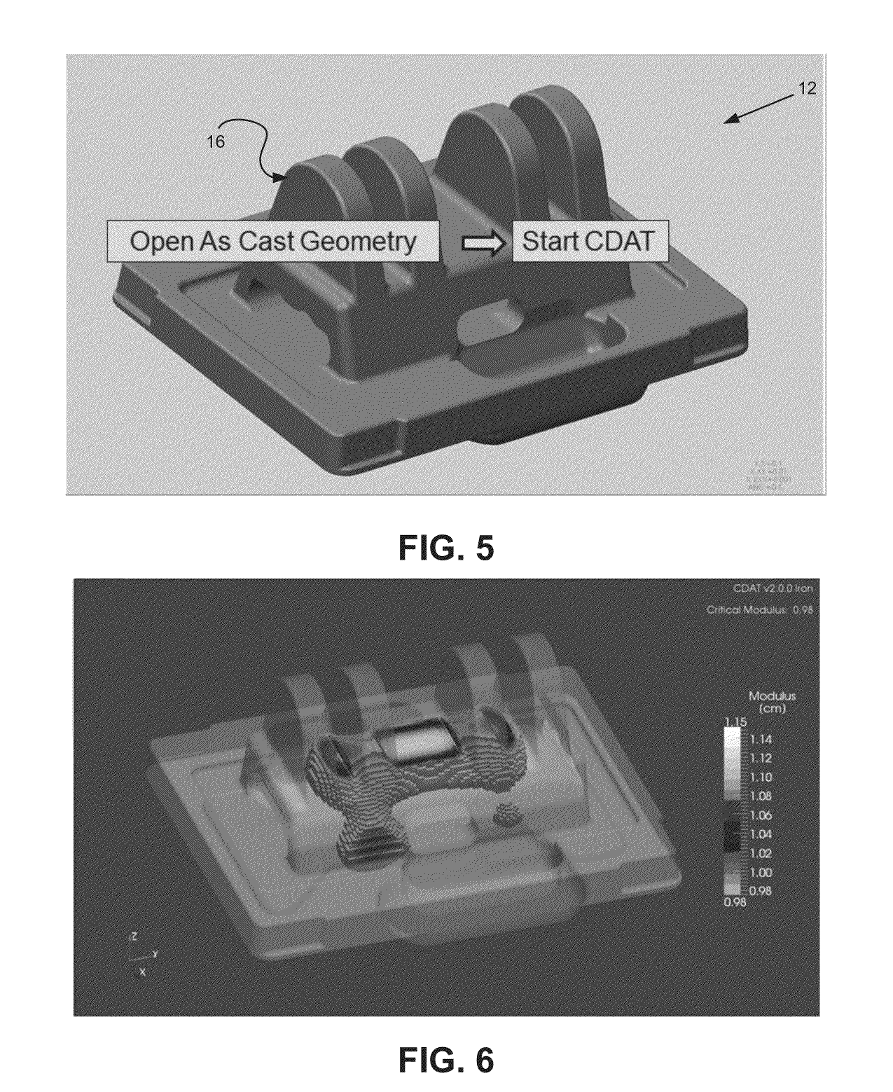

The present disclosure relates generally to improved systems and methods for providing advisement for cast component design. The disclosed systems and disclosures may be implemented using a computing device, such as the computer 100 of FIG. 4. For example, the example output displays of FIGS. 5-7 show implementation of the systems and methods in a computer aided design environment in accordance with the present disclosure. The output may be presented by, for example, the output device(s) 158 of the computer 100 of FIG. 4.

In FIG. 5, a display is shown wherein an example modifiable casting design 16 is presented in an integrated design environment 12, such as computer aided design software. The modifiable casting design 16 may be a three-dimensional image which is may be modified and manipulated by user input. Using the systems and methods described above, the CDAT 10 may analyze the modifiable casting design 16 and provide advisement to the user via the output device(s) 158 of the computer 100.

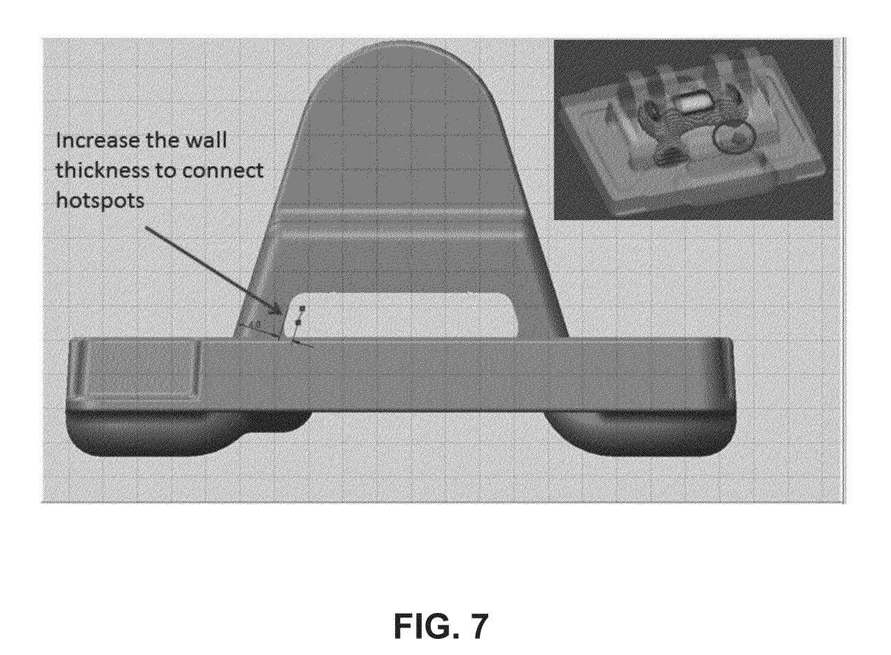

A non-limiting example of solidification analysis which may be provided by the CDAT 10 is shown in FIG. 6. In the example analysis, the CDAT 10 using, for example, the solidification module 22, performs solidification analysis on the modifiable casting design 16. The results of said solidification analysis are shown directly on the modifiable casting design 16 and may identify potential solidification issues occurring during casting. As seen in FIG. 7, the results of the solidification analysis may be used to provide guidance to a user of how to modify the modifiable casting design to overcome defects in the design based on solidification.

The aforementioned systems and methods for providing casting design advisement may provide a quicker design process by running all modules in parallel, therefore reducing computational time and improving efficiency. Additionally, the CDAT 10 may provide a user friendly system, reducing the need for experts to run the software.

It will be appreciated that the present disclosure provides a system, method, and instructions for providing casting design advisement in production of cast components. While only certain embodiments have been set forth, alternatives and modifications will be apparent from the above description to those skilled in the art. These and other alternatives are considered equivalents and within the spirit and scope of this disclosure and the appended claims.

What is claimed is:

1. A system for providing casting design advisement for designing a cast component, the system comprising:
an integrated design environment, the integrated design environment receiving a concept design for the cast component, the concept design being user-modifiable;
a plurality of design advisory modules associated with the integrated design environment, the plurality of design advisory modules determining physics models associated with the concept design for the cast component and providing advisement analysis for the concept design based on the physics models; and
a design rule logic solver, the design rule logic solver receiving concept design features associated with the concept design and comparing the concept design features with stored casting design rules to determine a geometry modification guide.

2. The system of claim 1, further comprising a cost analysis module, the cost analysis module performing a cost analysis on a potential manufacture of the concept design.

3. The system of claim 1, further comprising a geometry features analysis module for determining the casting design features associated with the concept design.

4. The system of claim 1, wherein the plurality of design advisory modules includes a material performance module for performing a material performance analysis on the concept design.

5. The system of claim 1, wherein the plurality of design advisory modules includes a solidification module for performing a solidification analysis on the concept design.

6. The system of claim 1, wherein the plurality of design advisory modules includes a heat treatment module for performing a heat treatment analysis on the concept design.

7. The system of claim 1, wherein the plurality of design advisory modules includes a hot tear analysis module for performing a hot tear analysis on the concept design.

8. The system of claim 1, wherein the plurality of design advisory modules includes a machining analysis module for performing a machining analysis on the concept design.

9. A method for providing advisement for designing a cast component, the method comprising:
receiving a concept design for the cast component at an integrated design environment, the concept design being user-modifiable;
determining, using a processor, one or more physics models associated with the concept design for the casting component;
providing advisement analysis for the concept design based on the one or more physics models;
receiving, by a design rule logic solver, concept design features associated with the concept design; and
determining, using the design logic solver, a geometry modification guide by comparing the casting design features with stored casting design rules.

10. The method of claim 9, further comprising performing a cost analysis for the concept design.

11. The method of claim 9, further comprising extracting the concept design features from the concept design.

12. The method of claim 9, further comprising:
determining a material performance model associated with the concept design for the cast component; and
providing advisement analysis for the concept design based on the material performance model.

13. The method of claim 9, further comprising:
determining a solidification model associated with the concept design for the cast component; and
providing advisement analysis for the concept design based on the solidification model.

14. The method of claim 9, further comprising:
determining a heat treatment model associated with the concept design for the cast component; and
providing advisement analysis for the concept design based on the heat treatment model.

15. The method of claim 9, further comprising:
determining a hot tear analysis model associated with the concept design for the casting component; and
providing advisement analysis for the concept design based on the hot tear analysis model.

16. The method of claim 9, further comprising:
determining a machining analysis model associated with the concept design for the cast component; and
providing advisement analysis for the concept design based on the machining analysis model.

17. A non-transitory, computer readable medium having thereon computer-executable instructions for providing advisement for designing a cast component, the instructions comprising:
instructions for receiving a concept design for the cast component at an integrated design environment, the concept design being user-modifiable;
instructions for determining one or more physics models associated with the concept design for the cast component;
instructions for providing advisement analysis for the concept design based on the one or more physics models;
instructions for receiving concept design features associated with the concept design by a design rule logic solver; and
instructions for determining a geometry modification guide by comparing the casting design features with stored casting design rules.

18. The non-transitory, computer readable medium having thereon computer-executable instructions for providing advisement for designing a cast component of claim 17, wherein the instructions further comprise providing a cost analysis for the concept design.

19. The non-transitory, computer readable medium having thereon computer-executable instructions for providing advisement for designing a cast component of claim 17, wherein the one or more physics models includes at least one of a material performance model, a solidification model, a heat treatment model, a hot tear analysis model, and a machining analysis model.

20. The non-transitory, computer readable medium having thereon computer-executable instructions for providing advisement for designing a cast component of claim 17, wherein the determined physics models include at least one of a material performance model, a solidification model, a heat treatment model, a hot tear analysis model, and a machining analysis model.
